(19) United States
(12) Patent Application Publication
(10) Pub. No.: US 2010/0274918 A1
(43) Pub. Date: Oct. 28, 2010

(54) STREAM DATA MULTIPLEXING DEVICE AND MULTIPLEXING METHOD

(76) Inventors: Yoshiaki Mimata, Osaka (JP); Kenji Iwahashi, Osaka (JP); Tomokazu Uchida, Kyoto (JP)

Correspondence Address: MCDERMOTT WILL & EMERY LLP, 600 13TH STREET, NW, WASHINGTON, DC, 20005-3096, US

(21) Appl. No.: 12/810,105

(22) PCT Filed: Nov. 19, 2008
(86) PCT No.: PCT/JP2008/003379

§ 371 Date: Jun. 22, 2010

(30) Foreign Application Priority Data
Feb. 4, 2008 (JP) 2008-024139

(51) Int. Cl. G06F 15/16

(52) U.S. Cl. 709/231; 709/234

(57) ABSTRACT

A comparative time of a first data stream accumulated in a buffer memory is compared with a comparative time of a second data stream (S113). If the comparative time of the first data stream is earlier, the first data stream is multiplexed (S114). On the other hand, if the comparative time of the first data stream is later, the first data stream is not immediately multiplexed. When a data stream is accumulated in a buffer memory, the comparative time of the data stream is a multiplexing reference time indicating the timing of reproduction of the data stream, which is obtained based on time information contained in the data stream or the like (S116). On the other hand, when a data stream is not accumulated in a buffer memory, a multiplexing predicted time which is predicted as the multiplexing reference time of a data stream which is to be next accumulated is used as the comparative time of the data stream (S117). As a result, data streams which should be simultaneously reproduced can be easily sorted and multiplexed even when smaller-size buffers are employed.

### TECHNICAL FIELD

The present invention relates to devices and methods for multiplexing a plurality of types of data streams, such as video data, audio data, and the like.

### BACKGROUND ART

In, for example, digital cameras and the like, when a plurality of types of data streams, such as video data, audio data, and the like, are recorded to a recording medium, such as a disk or the like, or are sent out to a transmission channel, the data streams are multiplexed.

There is, for example, a conventional multiplexing device which includes buffers which temporarily accumulate input data streams which are generated (encoded) or transmitted, and multiplexes each data stream every time the data stream reaches an amount sufficient to allow multiplexing.

There is another multiplexing device which multiplexes a first data stream (e.g., video data) every time the first data stream accumulated in a buffer reaches an amount sufficient to allow multiplexing, and when the first data stream is multiplexed, multiplexes a second data stream (e.g., audio data) corresponding to the first data stream (i.e., a second data stream which should be reproduced simultaneously with the first data stream) if the second data stream reaches an amount sufficient to allow multiplexing. In other words, this multiplexing device does not multiplex the second data stream immediately even when the second data stream reaches an amount sufficient to allow multiplexing.

There is also a proposed technique of, even when a data stream is input in a burst mode, calculating a virtual cumulative amount of the data stream in a buffer based on, for example, the rate at which the data stream is encoded, and controlling the timing of multiplexing based on the virtual cumulative data amount (see, for example, PATENT DOCUMENT 1).

### Citation List

### Patent Document

PATENT DOCUMENT 1: Japanese Patent Laid-Open Publication No. H09-139720

### SUMMARY OF THE INVENTION

### Technical Problem

However, in the multiplexing device which multiplexes each data stream every time the data stream reaches an amount sufficient to allow multiplexing, the size of the buffer required for the multiplexing device can be reduced. However, multiplexing positions in multiplexed data of video data, audio data, and the like which should be simultaneously reproduced tend to be separated from each other. Therefore, a large-size buffer is required by a reproduction apparatus which reproduces the multiplexed data.

On the other hand, in the device in which multiplexing of a second data stream is delayed until a first data stream is multiplexed, a large-size buffer is required to buffer the second data stream. In particular, the buffer size needs to be increased as the interval between when a first data stream is multiplexed and when the next first data stream is multiplexed increases.

In the device which controls the timing of multiplexing based on the virtual cumulative amount of data in the buffer, even when the actual cumulative amount of data in the buffer becomes large due to a data stream which is input in a burst mode, then if the virtual cumulative amount of data in the buffer is small, multiplexing is not performed. In this case, because the actual cumulative amount of data in the buffer continues to increase, the size of the buffer cannot always be reduced.

The present invention has been made in view of the aforementioned problems. It is an object of the present invention to reduce the buffer size, and cause the multiplexing positions in multiplexed data of data streams which should be simultaneously reproduced to be close to each other.

### Solution to the Problem

To achieve the aforementioned object, an example stream data multiplexing device of the present invention is a multiplexing device for multiplexing a plurality of types of data streams, including buffer memories configured to temporarily accumulate the respective types of data streams, a multiplexer configured to multiplex data streams accumulated in the buffer memories, and a multiplexing controller configured to control the data streams to be multiplexed. The multiplexing controller controls the data streams to be multiplexed, based on a multiplexing reference time calculated based on time information contained in a data stream accumulated in a first one of the buffer memories, and a multiplexing predicted time which, when there is a second one of the buffer memories in which a data stream has not been accumulated, is predicted as a multiplexing reference time of a data stream which is to be subsequently accumulated in the second one of the buffer memories.

As a result, for example, data streams to be multiplexed are determined by comparing multiplexing reference times, whereby the data streams to be multiplexed are easily sorted. Moreover, because data streams to be multiplexed can be determined by comparing the multiplexing reference time and the multiplexing predicted time, whereby, even if there is a data stream which is not accumulated, a data stream to be multiplexed can be determined, resulting in quicker multiplexing.

### Advantages of the Invention

According to the present invention, the buffer size can be reduced, and in addition, the multiplexing positions in multiplexed data of data streams which should be simultaneously reproduced can be caused to be closer to each other.

### BRIEF DESCRIPTION OF THE DRAWINGS

FIG. 1 is a block diagram showing a configuration of a multiplexing device according to a first embodiment.

FIG. 2 is a flowchart showing a buffer accumulation monitoring process of the multiplexing device of the first embodiment.

FIG. 3 is a flowchart showing a multiplexing control process of the multiplexing device of the first embodiment.

FIG. 4 is a diagram for describing a specific example of multiplexing in the multiplexing device of the first embodiment.

FIG. 5 is a block diagram showing a configuration of a multiplexing device according to a second embodiment.

FIG. 6 is a block diagram showing a configuration of a multiplexing device according to a third embodiment.

FIG. 7 is a diagram for describing a specific example of multiplexing in the multiplexing device of the third embodiment.

FIG. 8 is a block diagram showing a configuration of a multiplexing device according to a fourth embodiment.

### DESCRIPTION OF REFERENCE CHARACTERS

### 101, 111 First and Second Data Stream Generators

### 102, 112 Buffer Memory

### 103 Multiplexing Controller

### 104 Multiplexer

### 105 Selector

### 201, 211 Skip Determiner

### 301, 311 Buffer Monitoring Unit

### 401, 411 Timer Monitoring Unit

### DESCRIPTION OF EMBODIMENTS

Embodiments of the present invention will be described hereinafter with reference to the accompanying drawings. Note that like parts are indicated by like reference characters and will not be repeatedly described.

### First Embodiment of the Invention

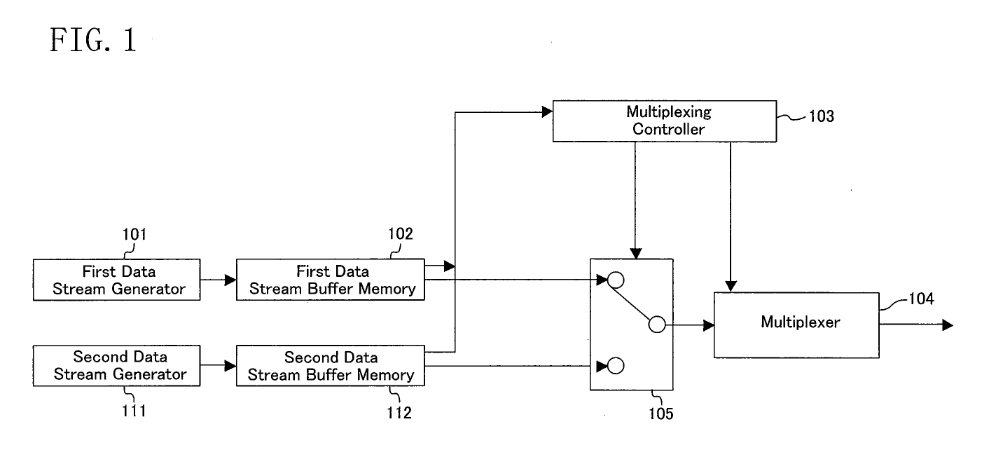

FIG. 1 is a block diagram showing a configuration of a multiplexing device according to a first embodiment of the present invention. For the sake of simplicity, in examples described below, data streams to be multiplexed are, for example, audio data, video data, and the like, and the number of the data streams (types) is assumed to be two.

The multiplexing device includes first and second data stream generators 101 and 111, buffer memories 102 and 112, a multiplexing controller 103, a multiplexer 104, and a selector 105.

The first and second data stream generators 101 and 111 encode an analog signal, such as audio, video, or the like, to generate a data stream. Note that the first and second data stream generators 101 and 111 not only are those which generate and output a new data stream, but may also be those which receive and output a data stream transmitted by broadcasting, a network, or the like. Alternatively, the first and second data stream generators 101 and 111 may not necessarily be included in a multiplexing device, and a data stream may be directly input from the outside.

The buffer memories 102 and 112 temporarily accumulate a data stream input from the first and second data stream generators 101 and 111, respectively. The selector 105 selects a data stream which is accumulated in one of the buffer memories 102 and 112. The multiplexer 104 multiplexes a data stream selected by the selector 105 and outputs multiplexed data in, for example, packets having a fixed length.

The multiplexing controller 103 controls selection operation of the selector 105 and multiplexing operation of the multiplexer 104. More specifically, the multiplexing controller 103 performs a control so that a first or second data stream is selected in order of comparative time which is a multiplexing reference time indicated by time information, such as a data stream time stamp, a program clock reference (PCR) for synchronization of reproduction times, or the like, which are contained in a data stream accumulated in the buffer memory 102, i.e., a timing at which a data stream should be reproduced. When the buffer memory 102 is empty, a multiplexing predicted time which is predicted as a multiplexing reference time of a data stream to be next accumulated is calculated, and is used as the comparative time to determine a data stream to be multiplexed.

The multiplexing predicted time is calculated by, for example, adding, to the multiplexing reference time of the most recently multiplexed data stream, an average period of time (an accumulation interval, such as an accumulation start interval, an accumulation end interval, or the like) which is required for a first or second data stream which is in an amount sufficient to allow multiplexing to be accumulated in the buffer memory 102 or 112. The accumulation interval may be, for example, calculated as a packet length/encoding rate if it is assumed that a first or second data stream is accumulated in the buffer memory 102 or 112 at a constant average rate (e.g., an encoding rate), and multiplexed data is generated in packets having a fixed length.

Specifically, the multiplexing reference times of accumulated first and second data streams (the leading data stream if a plurality of first or second data streams are accumulated) are held as comparative times, and are compared so that the accumulated first and second data streams are multiplexed in order of comparative time. As a result, first and second data streams which should be simultaneously reproduced can be multiplexed so that the multiplexing positions of the first and second data streams are close to each other.

When no second data stream is accumulated in the buffer memory 112, for example, a multiplexing predicted time is held as a second data stream comparative time. When the multiplexing reference time of a first data stream is earlier than the second data stream comparative time, the first data stream is multiplexed. On the other hand, when the multiplexing reference time of a first data stream is later than the second data stream comparative time, multiplexing is not immediately performed. As a result, in the former case, the first data stream is multiplexed without waiting until a second data stream is actually accumulated, and in the latter case, the first data stream is multiplexed after a second data stream is accumulated and multiplexed. Therefore, while reducing the capacities of the buffer memories 102 and 112 to smaller values, it is possible to, for example, prevent reversal of the order of multiplexing, or even if there is such a reversal, limit the difference in multiplexing position to a small level, i.e., packets at the same times can be more sorted and multiplexed.

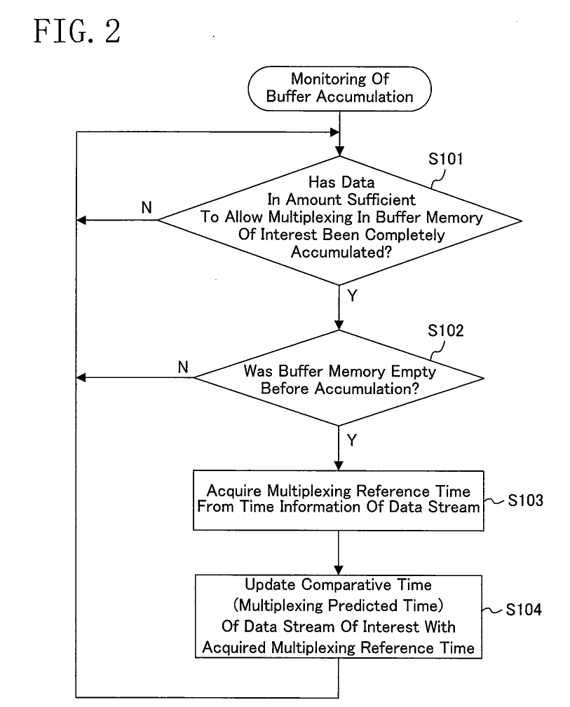

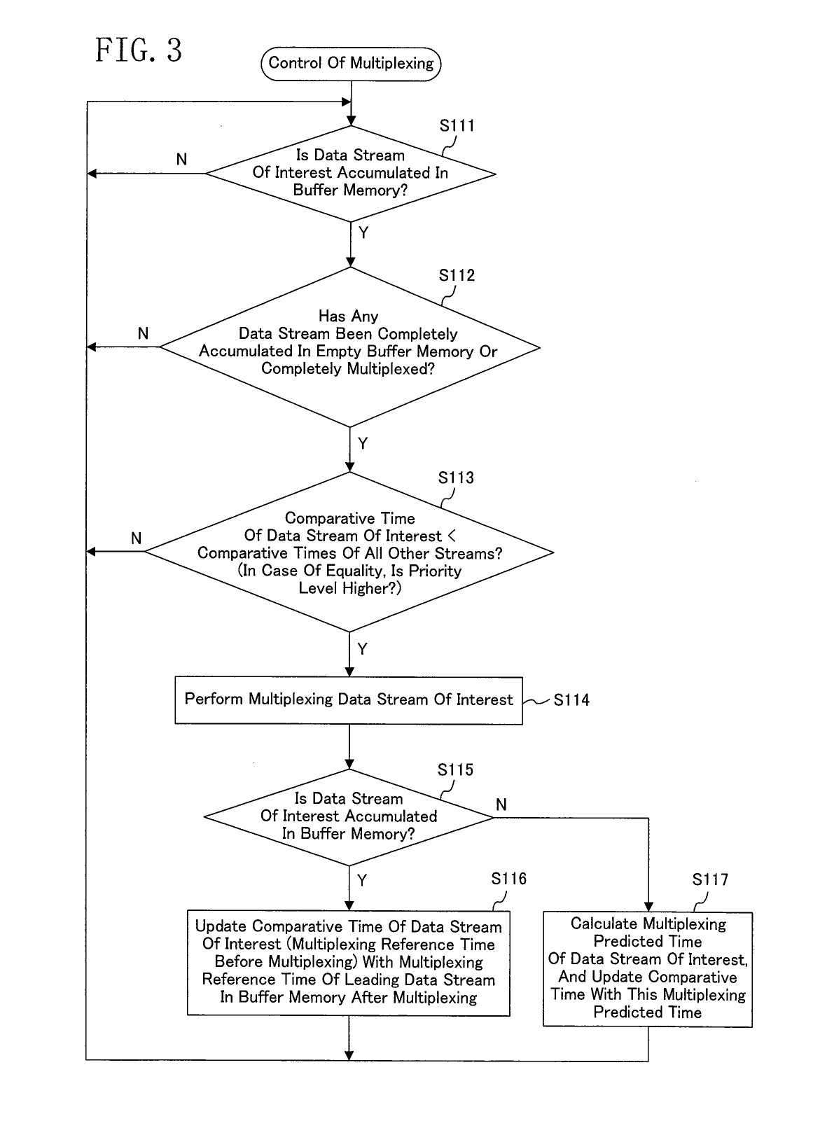

Next, specific example processes for the aforementioned control will be described with reference to FIGS. 2 and 3. These processes are repeatedly performed for each data stream. A case where the processes are performed with respect to a first data stream will be mainly described hereinafter.

(Monitoring of Accumulation in Buffer)

(S101) Initially, it is determined whether or not a first data stream generated by the first data stream generator 101 which is in an amount sufficient to allow multiplexing has been stored in the buffer memory 102. If the determination is negative, this monitoring is repeated.

(S102) If a data stream which is in an amount sufficient to allow multiplexing has been stored in the buffer memory 102, it is determined whether or not the buffer memory 102 was empty before the accumulation. If the determination is negative, the multiplexing reference time of the leading data stream which has already been accumulated is directly used as a comparative time, and therefore, control returns to (S101), in which the monitoring is further repeated.

(S103) On the other hand, if the buffer memory 102 was empty before the accumulation, a multiplexing predicted time was held as a comparative time. In order to update this, a multiplexing reference time is calculated based on time information contained in the newly accumulated data stream.

(S104) The multiplexing predicted time which was held as a comparative time is updated with the aforementioned calculated multiplexing reference time. Thereafter, the step (S101) and the subsequent steps are repeated.

The same steps are performed with respect to a second data stream to monitor the accumulation of the buffer memory 112 and update the comparative time.

(Control of Multiplexing)

(S111) Initially, it is determined whether or not a first data stream which is in an amount sufficient to allow multiplexing has been accumulated in the buffer memory 102. If the determination is negative, the monitoring is repeated until multiplexing is allowed.

(S112) On the other hand, if a first data stream which is in an amount sufficient to allow multiplexing has been accumulated in the buffer memory 102, then it is determined whether or not any data stream which is in an amount sufficient to allow multiplexing has been accumulated in the buffer memory 102 or 112 after starting from the empty state, or whether or not multiplexing described below has been completed. If none of the cases is positive, control returns to (S111), in which the monitoring of accumulation of the buffer memory 102 is repeated. On the other hand, if any of the cases is positive, the following process is performed. Specifically, if any of the cases is positive, the comparative time of the data stream is updated, and comparison described below (S113) is performed with respect to the comparative time. Note that such a determination is not always performed. For example, if a data stream has been accumulated in each of the buffer memories 102 and 112, the comparison of (S113) may always be performed.

(S113) The comparative times of the first and second data streams are compared. If the comparative time of the first data stream is earlier, control proceeds to (S114), in which the first data stream is multiplexed. If the comparative time of the first data stream is later, control returns to (S111), in which multiplexing is not immediately performed. In other words, a data stream having an earlier comparative time is multiplexed with priority. Here, when the comparative times of the first and second data streams are equal to each other, the first data stream is first multiplexed in accordance with priority levels which are previously given to the data streams. The present invention is not limited to this. Alternatively, a data stream for which the determination step (S113) has been first performed may be multiplexed.

(S114) The first data stream is selected by the selector 105, and is multiplexed by the multiplexer 104. (S115) After the multiplexing, it is determined whether or not a first data stream which is in an amount sufficient to allow multiplexing still remains in the buffer memory 102. If the determination is positive, control proceeds to (S116). On the other hand, if the determination is negative, control proceeds to (S117).

(S116) If a first data stream which is in an amount sufficient to allow multiplexing still remains in the buffer memory 102, a multiplexing reference time is calculated based on time information contained in the first data stream (the leading first data stream if the first data stream is in an amount sufficient to allow multiplexing multiple times), and the comparative time is updated with the multiplexing reference time. Thereafter, the step (S112) and the subsequent steps are repeated. Specifically, based on the multiplexing reference time of the actually accumulated first data stream, it is determined whether or not the first data stream is to be multiplexed.

(S117) On the other hand, when the buffer memory 102 becomes empty, a multiplexing predicted time is calculated as described above, the comparative time is updated with the multiplexing predicted time, and the step (S112) and the subsequent steps are repeated. Specifically, even when a first data stream has not been actually accumulated, it is determined whether or not another data stream is to be multiplexed, based on the multiplexing predicted time.

The same process is performed with respect to a second data stream, i.e., multiplexing is performed while the comparative time is compared and updated.

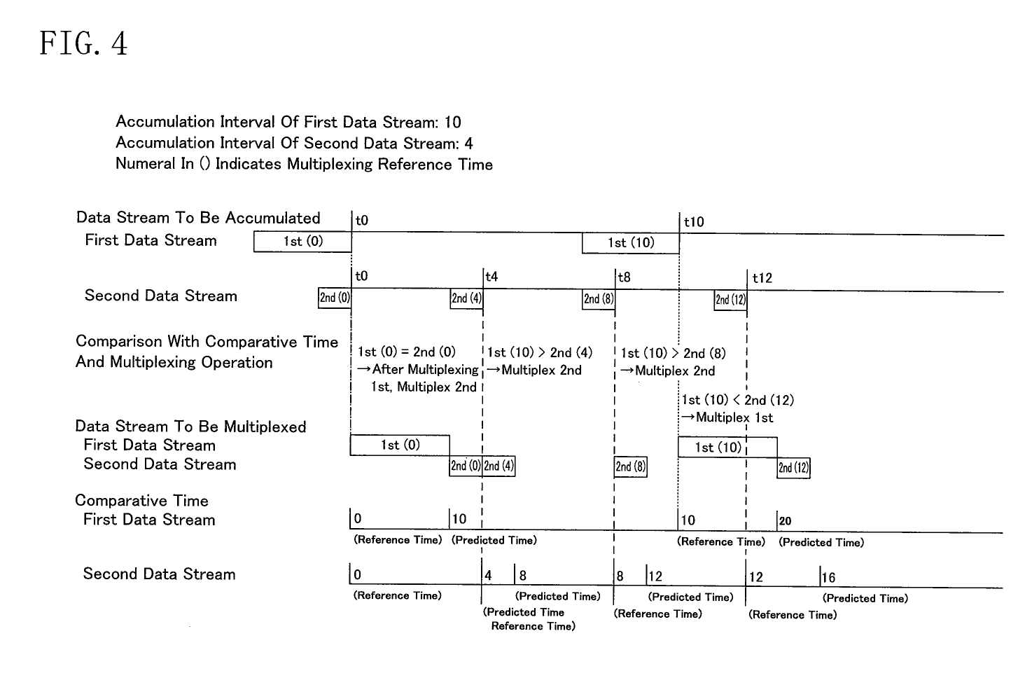

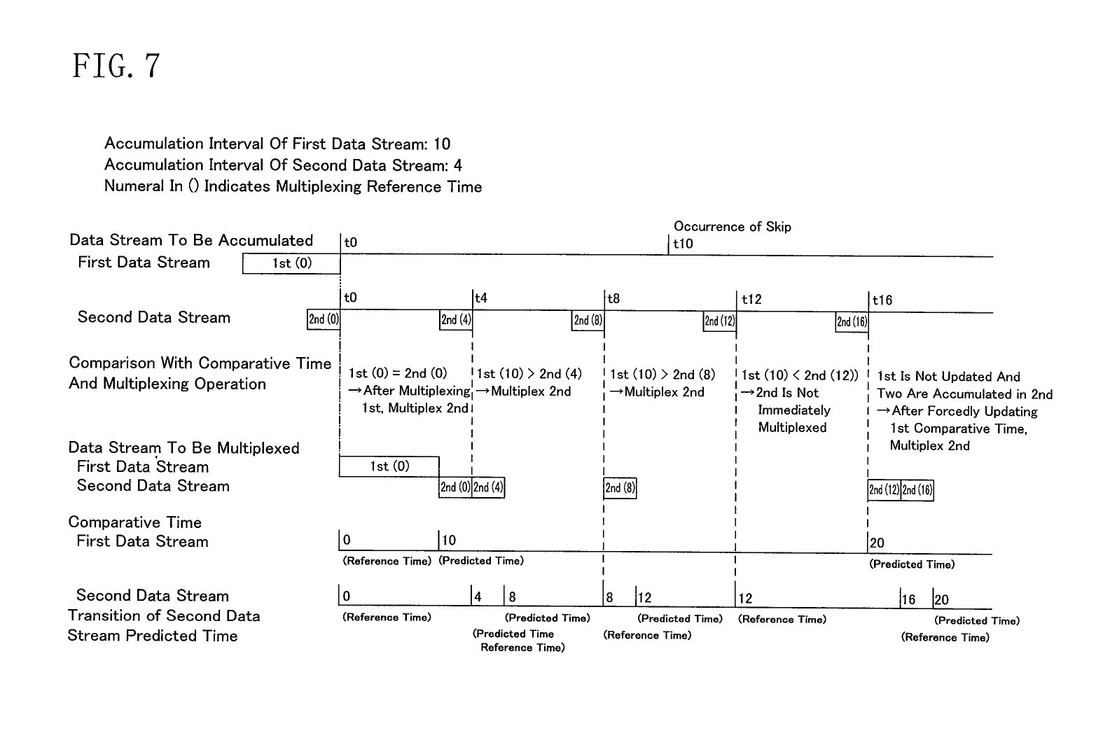

A specific example of the multiplexing performed by the aforementioned control will be described with reference to FIG. 4. In this example, it is assumed that the accumulation interval of first data streams is 10, and the accumulation interval of second data streams is 4. In FIG. 4 (and FIG. 7), a numeral in parentheses added to the end of the name of a data stream indicates a reference time of the data stream (e.g., “0” in a first data stream (0), etc.).

Initially, if it is assumed that first and second data streams (0) are both completely accumulated at time t0, a multiplexing reference time “0” is held as a comparative time in the buffer accumulation monitoring process (FIG. 2) for each of the data streams (S101-S104).

In the multiplexing control process of each data stream, it is determined whether or not accumulation of the data stream is present (S111 and S112). Thereafter, the comparative times (multiplexing predicted times) of the data streams are compared (S113). In this case, because the comparative times of the first and second data streams are equal to each other, i.e., both are “0.” Therefore, as described above, the first data stream (0) is multiplexed (S114), while the second data stream (0) is not multiplexed at this time. When the first data stream is completely multiplexed, the buffer memory 102 becomes empty (S115). In this case, the multiplexing reference time “0” of the completely multiplexed first data stream (0) is added to the accumulation interval “10,” and the resultant multiplexing predicted time “0+10=10” is held as a comparative time (S117).

After completion of multiplexing of the first data stream (0), the multiplexing control process is performed with respect to a second data stream. In this multiplexing control process, because the comparative time “0” of the second data stream (0) is earlier than the first data stream comparative time “10” (S113), the second data stream (0) is multiplexed (S114). When the multiplexing of the second data stream (0) is completed, a new multiplexing predicted time “0+4=4” is held as a comparative time (S117). Thereafter, at time t4, when the next second data stream (4) is completely accumulated, a multiplexing reference time “4” of the second data stream (4) is held as a comparative time (in this example, the resultant numerical value is the same) (S101-S104). In this case, because the comparative time “4” of the second data stream is earlier than the first data stream comparative time “10” (S111-S113), the second data stream (4) is multiplexed without waiting for accumulation of the next first data stream (S114). After the multiplexing, a multiplexing predicted time “4+4=8” is held as a second data stream comparative time (S117).

Thereafter, first and second data streams are similarly multiplexed.

Although, in the aforementioned example, a multiplexing device having two types of data streams has been described, the present invention is not limited to this, and a multiplexing device having three or more types of data streams may be configured. Specifically, for example, in (S112) of FIG. 3, it is determined whether or not accumulation has been completed in a buffer memory after starting from the empty state, with respect to any one of all data streams. Also, in (S113), the comparative time of each data stream may be compared with the comparative times of all the other data streams, or alternatively, the comparative time of at least a comparative time(s) which has been updated may be compared with the comparative times of all the other data streams.

In the aforementioned example, when the comparative times of first and second data streams are equal to each other, a data stream to be multiplexed is determined, depending on the predetermined priority levels. The present invention is not limited to this. Alternatively, depending on the priority levels, one of the data streams may be multiplexed if the comparative time is later, but the difference in comparative time between the data streams is within a predetermined range, and the other data stream may not be immediately multiplexed if the comparative time is earlier, but the difference in comparative time between the data streams is within the predetermined range. Also, when a comparative time to be compared is a multiplexing predicted time, multiplexing may be performed if the difference is within the predetermined range, or the predetermined range may be changed, depending on whether or not a comparative time to be compared is a multiplexing predicted time, or such a control may be combined with the control depending on the priority level. Moreover, it may be determined whether or not multiplexing is to be performed, depending on the capacity or cumulative amount of a buffer, the type of a data stream, or the like.

Moreover, commonly used buffer control techniques, such as abandoning data when overflow occurs, stuffing when underflow occurs, and the like, may be available as long as there is no logical contradiction.

### Second Embodiment of the Invention

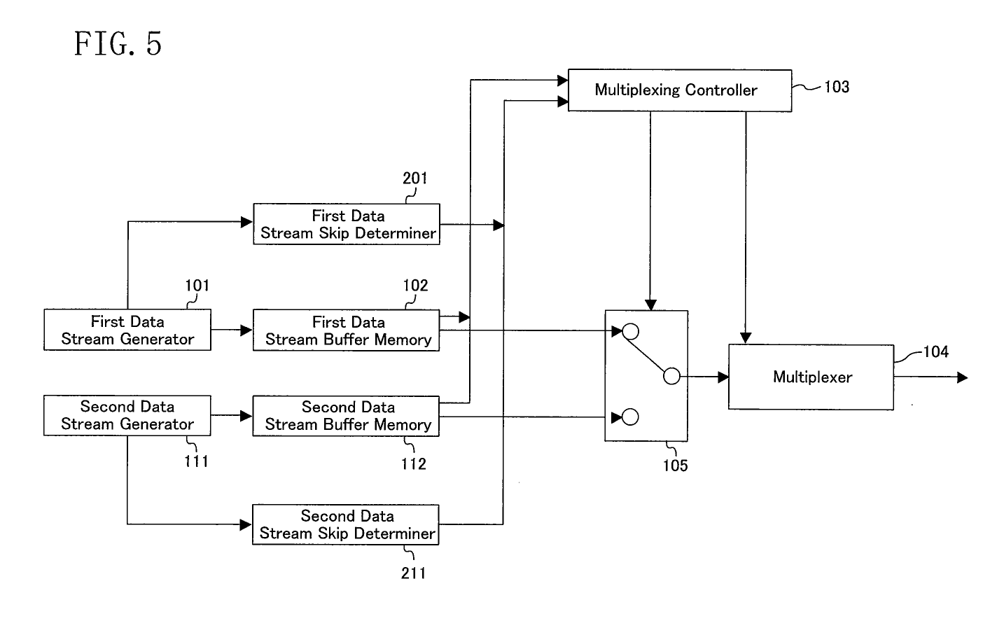

FIG. 5 is a block diagram showing a configuration of a multiplexing device according to a second embodiment of the present invention. The configuration of FIG. 5 is different from that of FIG. 1 mainly in that skip determiners 201 and 211 are provided. In this multiplexing device, when the first or second data stream generator 101 or 111 has failed to generate a data stream due to any cause, the skip determiner 201 or 211 determines that skipping has occurred, and notifies the multiplexing controller 103 of the occurrence. In response to this, the multiplexing controller 103 forcedly updates the multiplexing reference time of one of the data streams in which skipping has occurred with, for example, the next multiplexing predicted time which is obtained by adding the accumulation interval to the previous multiplexing reference time, and sets the updated multiplexing reference time as a comparative time.

In this case, even when the comparative time of the other data stream is later than the comparative time before updating of the data stream in which skipping has occurred, then if the comparative time of the other data stream is earlier than the updated comparative time, the other data stream is multiplexed. By performing such quick multiplexing, the buffer amounts of the buffer memories 102 and 112 can be reduced. Therefore, the capacities of the buffer memories 102 and 112 can be reduced.

### Third Embodiment of the Invention

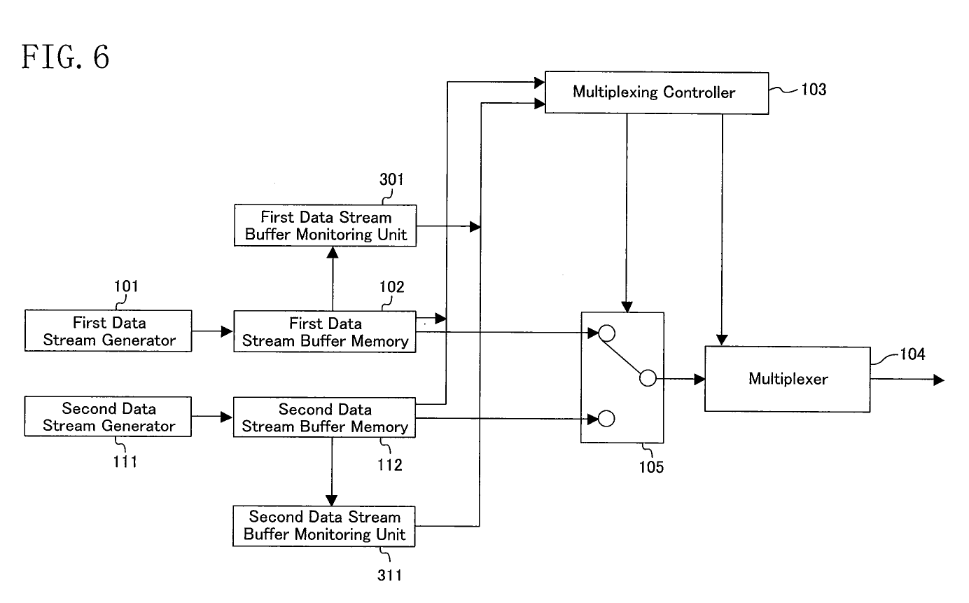

FIG. 6 is a block diagram showing a configuration of a multiplexing device according to a third embodiment of the present invention. The configuration of FIG. 6 is different from that of FIG. 1 mainly in that buffer monitoring units 301 and 311 are provided. In this multiplexing device, the buffer monitoring units 301 and 311 monitor whether or not the cumulative amounts of the buffer memories 102 and 112 have reached predetermined thresholds, respectively. When the cumulative amount of one of the buffer memories 102 and 112 has reached the predetermined threshold, the multiplexing controller 103 forcedly updates the comparative time of the other data stream with, for example, the next comparative time which is obtained by adding the accumulation interval to the previous comparative time.

Specific example operation will be described with reference to FIG. 7. Here, the cumulative amount thresholds of the buffer monitoring units 301 and 311 are each assumed to be an amount which allows multiplexing two times.

In this example, second data streams (0), (4), and (8) are successively accumulated in the buffer memory 112 and multiplexed in a manner similar to that described in the specific example of the first embodiment (FIG. 1). On the other hand, it is assumed that a first data stream is not input at time t10 due to occurrence of skipping or the like, and is not accumulated in the buffer memory 102. In this case, the first data stream comparative time is not updated and remains as the multiplexing predicted time “10.”

Therefore, even when the next second data stream (12) is input and accumulated at time t12, a comparative time “12” in this case is later than the first data stream comparative time “10,” and therefore, the second data stream is not multiplexed and remains accumulated in the buffer memory 112.

Next, at time t16, when a second data stream (16) is input and accumulated, the cumulative amount reaches an amount which allows multiplexing two times, and therefore, the buffer monitoring unit 311 notifies the multiplexing controller 103 that the cumulative amount has reached the threshold. Therefore, the first data stream comparative time is updated with, for example, that which is obtained by adding the accumulation interval to the previous first data stream comparative time, i.e., “10+10=20.” In this case, the multiplexing reference times (values which are to be successively set to comparative times) of the second data streams (12) and (16) accumulated in the buffer memory 112 are all earlier than the updated comparative time. Therefore, the second data streams (12) and (16) are successively multiplexed without waiting for actual input of a first data stream (10).

As described above, for example, even when a first data stream continues not to arrive in the buffer memory 102 due to skipping of generation of the first data stream, or even when the cumulative amount of the buffer memory 112 is large due to burst arrival of second data streams, a second data stream whose cumulative amount exceeds the threshold can be quickly multiplexed in a manner similar to that described in the second embodiment. Therefore, the capacities of the buffer memories 102 and 112 can be easily reduced.

Although, in the aforementioned example, the buffer monitoring units 301 and 311 are provided to monitor both the cumulative amounts of the buffer memories 102 and 112, the present invention is not limited to this. Alternatively, only one of the buffers may be monitored, depending on the type of a data stream, the capacity of the buffer, or the like.

Moreover, the cumulative amount thresholds of the buffers may not be the same, or may be different from each other.

Moreover, the value which is added when a comparative time is forcedly updated is not limited to the accumulation interval, or may be a value which can at least reduce the cumulative amount of the buffer.

### Fourth Embodiment of the Invention

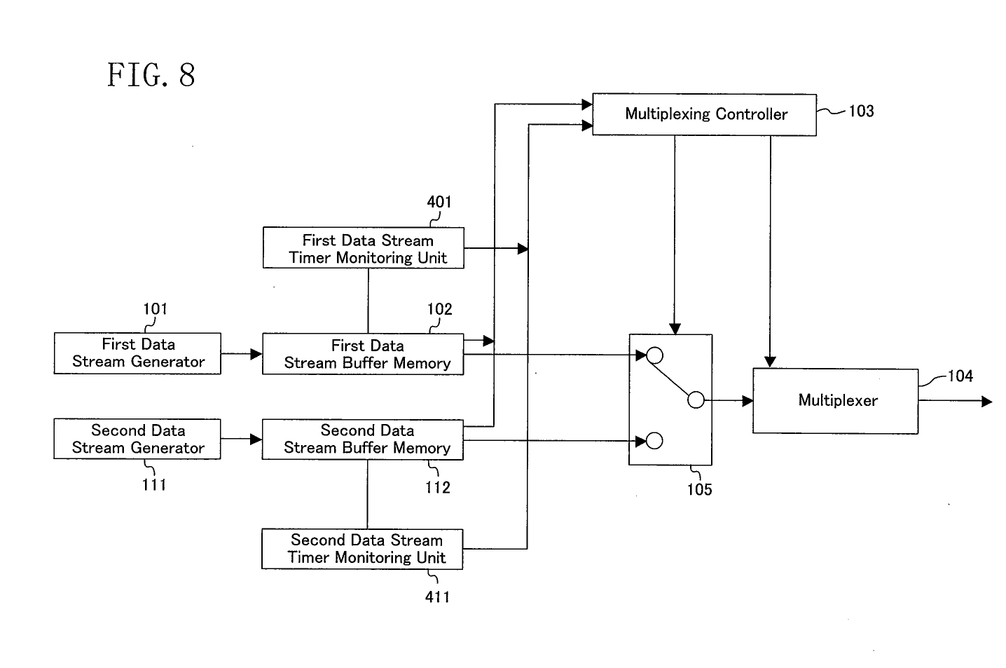

FIG. 8 is a block diagram showing a configuration of a multiplexing device according to a fourth embodiment of the present invention. The configuration of FIG. 8 is different from that of FIG. 1 mainly in that timer monitoring units 401 and 411 are provided. In this multiplexing device, the timer monitoring units 401 and 411 each include a timer. When a data stream has not arrived in the buffer memory 102 or 112 for a predetermined period of time or more, the corresponding timer monitoring unit 401 or 411 notifies the multiplexing controller 103 that a data stream has not arrived. In response to this, the multiplexing controller 103 forcedly updates the comparative time of a data stream which has not yet arrived, with the next comparative time. As a result, a data stream accumulated in the other buffer memory 102 or 112 can be quickly multiplexed.

Note that, also in the fourth embodiment, for only one of the buffers, it may be monitored whether or not a data stream has not arrived.

Moreover, the components described in the aforementioned embodiments and their variations may be combined as long as the combination is logically possible. Specifically, for example, a comparative time may be updated even when any of skipping of generation of a data stream, an increase in the cumulative amount of a buffer memory, and no arrival of a data stream occurs.

Moreover, a multiplexing reference time or a multiplexing predicted time may not be held as a comparative time, or alternatively, for example, may be calculated, or referenced from an accumulated data stream, when necessary.

### INDUSTRIAL APPLICABILITY

The multiplexing device and the multiplexing method of the present invention can advantageously reduce the buffer size, and cause the multiplexing positions in multiplexed data of data streams which should be simultaneously reproduced, to be close to each other, and are useful as multiplexing devices and multiplexing methods for multiplexing a plurality of types of data streams, such as video data, audio data, and the like.

1. A multiplexing device for multiplexing a plurality of types of data streams, comprising:
buffer memories configured to temporarily accumulate the respective types of data streams;
a multiplexer configured to multiplex data streams accumulated in the buffer memories; and
a multiplexing controller configured to control the data streams to be multiplexed, wherein
the multiplexing controller controls the data streams to be multiplexed, based on a multiplexing reference time calculated based on time information contained in a data stream accumulated in a first one of the buffer memories, and a multiplexing predicted time which, when there is a second one of the buffer memories in which a data stream has not been accumulated, is predicted as a multiplexing reference time of a data stream which is to be subsequently accumulated in the second one of the buffer memories.

2. The multiplexing device of claim 1, wherein
the multiplexer multiplexes the data streams accumulated in the buffer memories in data units of a fixed length.

3. The multiplexing device of claim 1, wherein
the data streams accumulated in the buffer memories are input at a constant average rate.

4. The multiplexing device of claim 1, wherein
the multiplexing controller, when first and second data streams are accumulated in the buffer memories, allows multiplexing of the first data stream having an earlier multiplexing reference time.

5. The multiplexing device of claim 4, wherein
the multiplexing controller allows multiplexing of the first data stream when the multiplexing reference time of the first data stream stored in the corresponding buffer memory is earlier than a multiplexing predicted time which is predicted for a second data stream which is not accumulated in the corresponding buffer memory.

6. The multiplexing device of claim 4, wherein
the multiplexing controller allows multiplexing of the first data stream when a difference between the multiplexing reference times is within a predetermined range.

7. The multiplexing device of claim 5, wherein
the multiplexing controller allows multiplexing of the first data stream when a difference between the multiplexing reference time and the multiplexing predicted time is within a predetermined range.

8. The multiplexing device of claim 1, wherein
the multiplexing controller, when one of the buffer memories becomes empty, adds a predetermined additional time period to the multiplexing reference time of the corresponding multiplexed data stream, and updates the multiplexing predicted time with the resultant multiplexing reference time.

9. The multiplexing device of claim 8, wherein
the predetermined additional time period is an accumulation interval of the corresponding data stream.

10. The multiplexing device of claim 1, wherein
the multiplexing controller allows multiplexing of data streams based on priority levels of the plurality of types of data streams.

11. The multiplexing device of claim 1, wherein
the multiplexing controller updates the multiplexing predicted time when there is a lack of a data stream which is to be accumulated in an empty one of the buffer memories.

12. The multiplexing device of claim 1, wherein
the multiplexing controller, when a cumulative amount of one of the buffer memories has reached a predetermined amount, updates the multiplexing predicted time of a data stream corresponding to another empty one of the buffer memories.

13. The multiplexing device of claim 1, wherein
the multiplexing controller, when a time period for which a data stream is not accumulated in an empty one of the buffer memories has reached to a predetermined time period, updates the multiplexing predicted time.

14. A method for multiplexing a plurality of types of data streams, comprising:
a multiplexing control step of determining a data stream to be multiplexed; and
a multiplexing step of multiplexing a data stream accumulated in a buffer memory in accordance with the determination of the multiplexing control step, wherein
the multiplexing control step determines the data stream to be multiplexed, based on a multiplexing reference time calculated based on time information contained in a data stream accumulated in a first buffer memory, and a multiplexing predicted time which, when there is a second buffer memory in which a data stream has not been accumulated, is predicted as a multiplexing reference time of a data stream which is to be subsequently accumulated in the second buffer memory.

15. The method of claim 14, wherein
the multiplexing control step includes determining a data stream to be multiplexed, based on priority levels of the plurality of types of data streams.

16. The method of claim 14, wherein
the multiplexing control step includes updating the multiplexing predicted time when there is a lack of a data stream which is to be accumulated in an empty buffer memory.

17. The method of claim 14, wherein
the multiplexing control step includes, when a cumulative amount of a buffer memory has reached a predetermined amount, updating the multiplexing predicted time of a data stream corresponding to another empty buffer memory.

18. The method of claim 14, wherein
the multiplexing control step includes, when a time period for which a data stream is not accumulated in an empty buffer memory has reached to a predetermined time period, updating the multiplexing predicted time.
